(19) United States
(12) Patent Application Publication
(10) Pub. No.: US 2003/0182181 A1
(43) Pub. Date: Sep. 25, 2003

(54) On-line benchmarking

(76) Inventors: Kenneth Scott Kirkwood, Amsterdam (NL); Albertus Josephus Koch, Voorburg (NL)

Correspondence Address: Joan M. McGillycuddy, Akzo Nobel Inc., IP Department, 7 Livingstone Avenue, Dobbs Ferry, NY, 10522, US

(21) Appl. No.: 10/387,365

(22) Filed: Mar. 12, 2003

Related U.S. Application Data
(60) Provisional application No. 60/381,644, filed on May 17, 2002.

(30) Foreign Application Priority Data
Mar. 12, 2002 (EP) 02075990.8

(51) Int. Cl. G06F 17/60

(52) U.S. Cl. 705/11

(57) ABSTRACT

Method for on-line performance analysis of a business entity using a server computer and one or more remote client computers linked to the server computer by a communication network, the method including:

providing a user interface on a client computer allowing input of performance data of the business entity;

defining one or more key performance indicators on the basis of the performance data;

providing a user interface on the client computer allowing selection of a type of comparative key performance indicator;

using the user's selection to generate one or more comparative key performance indicators on the basis of data of earlier sessions;

comparing one or more of the key performance indicators to the corresponding comparative key performance indicators;

deducing a performance analysis on the basis of the differences between the key performance indicators and the corresponding comparative key performance indicators, and

transferring the analysis to the client computer.

The server stores a database of performance parameters obtained from earlier sessions. A user interface is provided to the client computer, allowing input of one or more parameters for generating a comparative key performance indicator on the basis of a sub-database selected from the database on the basis of parameters inputted by the user. One or more central administrators, preferably of different levels, have access to the database of performance parameters, e.g., for statistical analysis.

This application claims the benefit of European Patent Application No.: 02075990.8 filed Mar. 12, 2002, and U.S. Provisional Patent Application No. 60/381,644 filed May 17, 2002.

### FIELD OF THE INVENTION

The present invention relates to a method for on-line performance analysis of a business entity using a server computer and one or more remote client computers linked to the server computer by a communication network.

### BACKGROUND OF THE INVENTION

WO 00/68861 discloses an Internet based benchmarking system. This system allows benchmarking for any type of business entity. If so desired, the user can benchmark against similar businesses, e.g. companies which are active in the same field. Similar systems are disclosed in WO 97/31320 and US 2001/0053993.

Although these systems allow benchmarking against similar companies, these systems are of a general nature. Benchmarking systems have been designed focusing on very specific markets, thus allowing more accurate benchmarking. An example of such a specific system is disclosed in international patent application WO 02/01453. This system is specifically designed for the vehicle repair business. This program enables a user to compare its performance to general standards. The standards may not be equally suitable for all users and may become outdated within a short time.

Vehicle repair shops for refinishing damaged cars, generally referred to as body shops, can differ considerably in size, in the types or numbers of cars they refinish, in the quality standards they wish to maintain, etc. Moreover, their performance is dependent on seasonal influences: in winter more car accidents occur than in summer. Comparing a car repair bodyshop with a general standard of performance therefore does not result in an accurate analysis.

### SUMMARY OF THE INVENTION

The object of the invention is to find an on-line benchmarking system resulting in a more accurate analysis.

The object of the invention is achieved with a method for on-line performance analysis of a business entity using a server computer and one or more remote client computers linked to the server computer by a communication network, the method including:

providing a user interface on a client computer allowing input of performance data of the business entity;

defining one or more key performance indicators on the basis of the performance data;

providing a user interface on the client computer allowing selection of a type of comparative key performance indicator;

using the user's selection to generate one or more comparative key performance indicators on the basis of data of earlier sessions;

comparing one or more of the key performance indicators to the corresponding comparative key performance indicators;

deducing a performance analysis on the basis of the differences between the key performance indicators and the corresponding comparative key performance indicators, and

transferring the analysis to the client computer.

### BRIEF DESCRIPTION OF THE DRAWINGS

FIG. 1: Flow diagram of a stage in the benchmarking process.

FIG. 2: Flow diagram of a performance report creation stage in the benchmarking process.

FIG. 3: Flow diagram of a benchmark comparison report type stage in the benchmarking process.

FIG. 4: Flow diagram of a stage in the benchmarking process.

FIG. 5A: An example of the use of comparative key performance indicators allowing customized benchmarking.

FIG. 5B: An example of the use of comparative key performance indicators allowing customized benchmarking.

FIG. 5C: An example of the use of comparative key performance indicators allowing customized benchmarking.

FIG. 5D: An example of the use of comparative key performance indicators allowing customized benchmarking.

FIG. 5E: An example of the use of comparative key performance indicators allowing customized benchmarking.

### DETAILED DESCRIPTION OF THE INVENTION

The system according to the present invention enables a car repair body shop to customize and fine-tune its benchmarking and to compare its performance with those of body shops in the same country or region, over the same period or in the same sub-market, or with those of body shops of similar size, number of employees, etc. The use of comparative key performance indicators allows customized queries defined by the user. This way, users define interactively their benchmark criteria. The data, on which these customized criteria are based, are continuously updated. If the body shop is part of a chain, e.g., a franchise chain, it can compare its performance with those of other franchisees or a relevant group among the franchisees.

Performance data can for example be financial parameters (e.g. costs per job, etc.), operational parameters (e.g. number of employees or total of vehicles repaired within a time period), or any other parameter considered to be relevant. Preferably, the performance data are quantitative operands suitable for use in a mathematical operation.

On the basis of the performance data, key performance indicators, often referred to as “KPI's”, are defined, e.g., by mathematical combination of quantitative performance parameters. The system of Key Performance Indicators is described in The KPI Book by Jeff Smith, edited by Insight Training and Development Ltd, 2001. An example would be labour gross profit, calculated from the performance data “labour sales” minus “labour cost of sales”, or sales per employee, calculated as “total sales” divided by “number of employees”.

The key performance indicators, defined on the basis of the input of a certain user, are compared with corresponding comparative key performance indicators. The differences between a key performance indicator and a corresponding comparative key performance indicator result in an analysis of the performance of the benchmarked business entity. For instance, if a key performance indicator is considerably lower than a corresponding comparative key performance indicator, performance of the business in question can be improved on that point. If, on the other hand, a key performance indicator is considerably higher than the corresponding comparative key performance indicator, performance of the business is generally considered to be satisfactory on the point in question.

A database of performance data and/or KPI's obtained from earlier sessions is used for defining a comparative key performance indicator for a user. This database can for instance be stored on the server computer. A sub-group can be selected from the database of performance parameters obtained from earlier sessions to define a customized comparative key performance indicator. The user can select which data are used to define suitable and relevant comparative key performance indicators. Alternatively, customized comparative key performance indicators can be generated automatically, e.g., by the server computer on the basis of the user's input. This allows the user to benchmark its business against comparable businesses, e.g., of comparable size in personnel terms, businesses active in comparable markets or in the same geographical market, etc.

Preferably, leakage of confidential information by detailing queries to such extent that only one or very few of the user's competitors would be used in a benchmarking session, should be prevented. Therefore, if a query would cover less than a given number of comparative business entities, one or more of the query criteria should be broadened to such extent that at least a pre-defined minimum of comparative businesses is covered. If for instance a user wants to benchmark its performance against the performances of businesses in the same geographical area, the user should select an area where a given minimum number of competitors is active in order to safeguard the confidentiality of the information.

In a preferred embodiment, the system allows benchmarking of the business's performance against its own forecast and/or its own prior performance results. Further, the system should preferably also allow historical comparison to give an overview over a selected period of time, e.g., the last month, the last year, etc. Optionally, the “granularity” of the results (monthly results, quarterly results, annual results, etc.) can be selected by the user.

A further possible embodiment could allow data import directly from body shop management systems such as CarInfo of Akzo Nobel.

Optionally, the database is accessible to a central administrator, who can use the data to compare the performance of a group of business entities with those of another group or with a total score, for instance for statistical analysis or trend analysis. The central administrator can contact the database either via a user interface of the server itself or also via the communication network. Preferably, the central administrator has the option to compare data over a certain period with data over a second period.

In a further preferred embodiment, the system can allow use by central administrators of different levels. For example, for a number of geographical markets central administrators can be supervised or monitored by a global central administrator. If separate geographical markets are assigned to different central administrators, the system can be further adapted to the specific needs of particular geographical markets. KPIs may be defined differently per country, for example if the KPI involves use of Si or Imperial units of measurement.

Optionally, the system according to the present invention may allow benchmarking on different levels. A user can select a relevant set of key performance indicators and/or select if these are defined by the most relevant performance parameters only or if these are defined in a more detailed way, e.g., by using more different performance parameters. For example, a user can be offered the option to select an analysis based on five KPIs, ten KPIs, 20 KPIs or 50 KPIs. Whereas for the very small, more traditional body shop a low profile benchmarking using only five KPIs would do, the more sophisticated, larger body shop automated to a larger degree would be served best with a detailed session using as many as 50 KPIs.

Errors may be included in a user's input. Since this could result not only in an inaccurate analysis but also in disordering the data from earlier sessions, these errors should preferably be filtered out. This can for instance be done by taking the user's input to a filter, which scans the input for errors.

The results of the performance analysis can for instance be reported by graphical output or cell data output which can be readily imported into the usual spreadsheet software, such as Excel® of Microsoft.

Besides the reports, the system may optionally also provide facilities, such as help files or best practices, or offer the possibility of group discussions, e.g., Internet newsgroups, or video conferencing, preferably via the same communication network, for instance via Internet based video conferencing software such as Microsoft's Netmeeting®, allowing discussion of the analysis with a consultant or with other business entities. Direct e-mail links to a consultant may also be incorporated, if so required.

The communication network can for instance be the Internet. Alternatively, the communication network can be an extranet or an intranet. It is preferred to use web technology to design the user interfaces of the system to optimize ease of use. Web technology can be used for implementation, allowing the user to use browser software, such as Internet Explorer® of Microsoft or Netscape's Navigator®, as a basis for the user interface of the system.

Since confidential information is communicated by the users, the information is preferably protected by password authentication, firewall technology and/or 128-bit encryption.

The present invention can involve a computer program for on-line performance analysis of a business entity using a server computer and one or more remote client computers linked to the server computer by a communication network, wherein the computer program:

defines one or more key performance indicators on the basis of a user's input of performance parameters;

consults a database of data obtained from earlier sessions to define one or more comparative key performance indicators;

compares the indicators to the corresponding comparative indicators;

deduces a performance analysis on the basis of the differences between the key performance indicators and the corresponding comparative key performance indicators.

Preferably, the computer program allows access to one or more central administrators, optionally of different levels, for statistical analysis of the data and/or for defining KPIs or further actions.

The computer program can be in any suitable programming language, but languages particularly suitable for web application, such as Java, are preferred.

The computer program according to the invention can be stored on a data carrier, such as a CD ROM, a hard disk, a tape or any further suitable medium for memory storage.

The computer program can be stored or run on a server computer that can comprise a memory storage medium storing a database of data obtained from earlier sessions. Alternatively, the server can consult the database at another source.

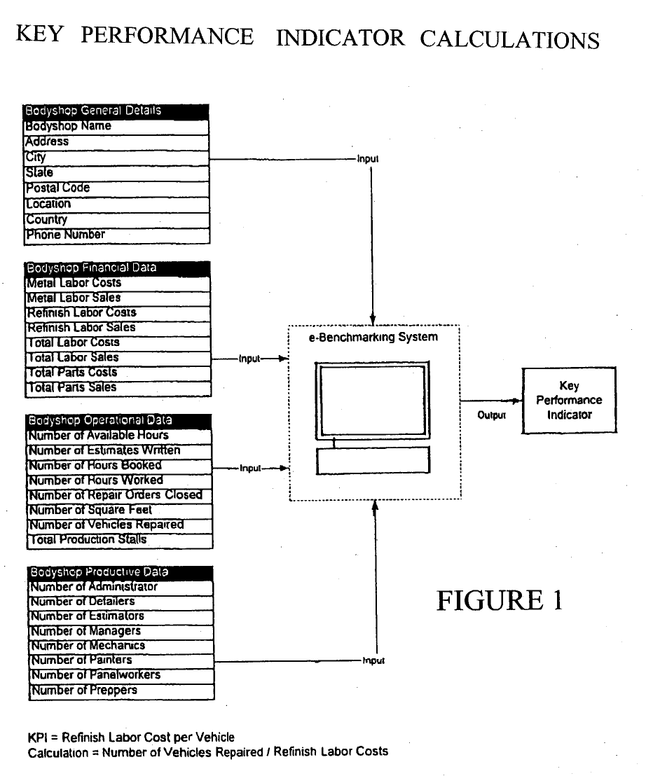

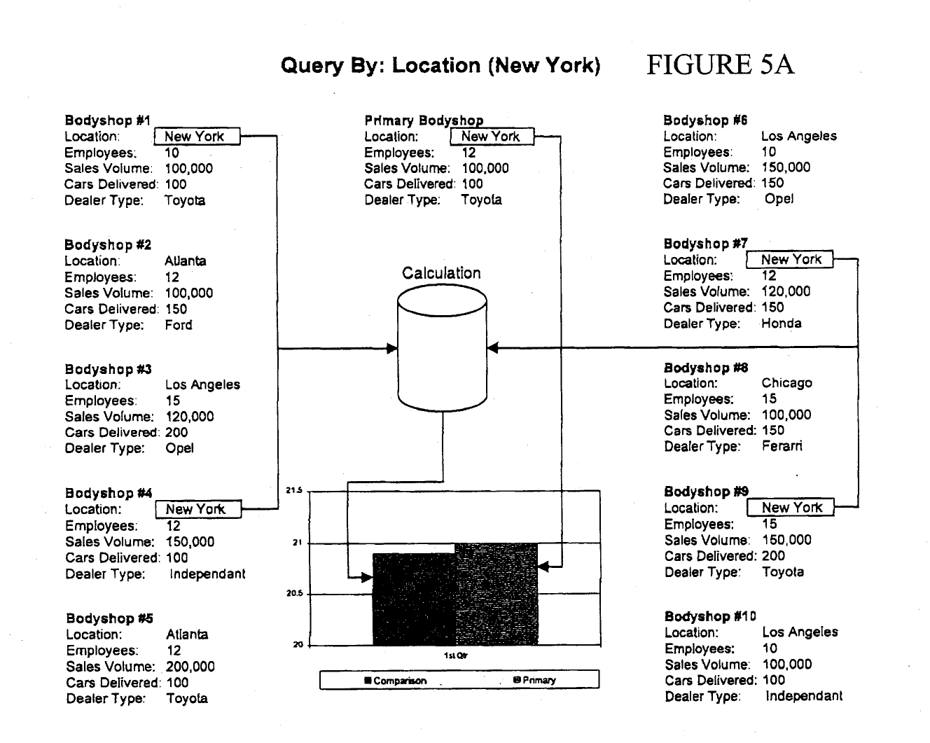

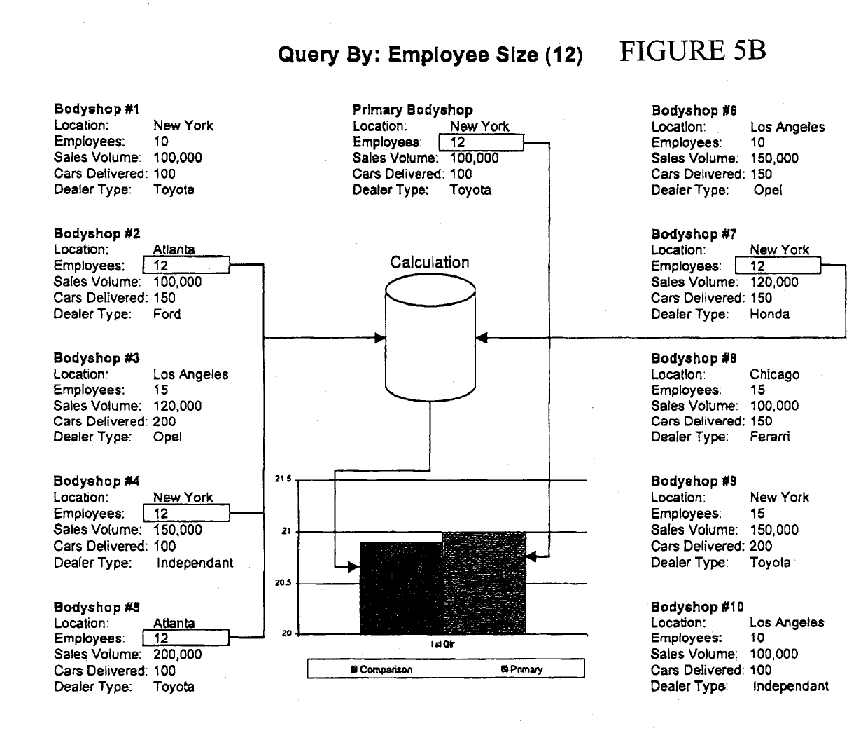

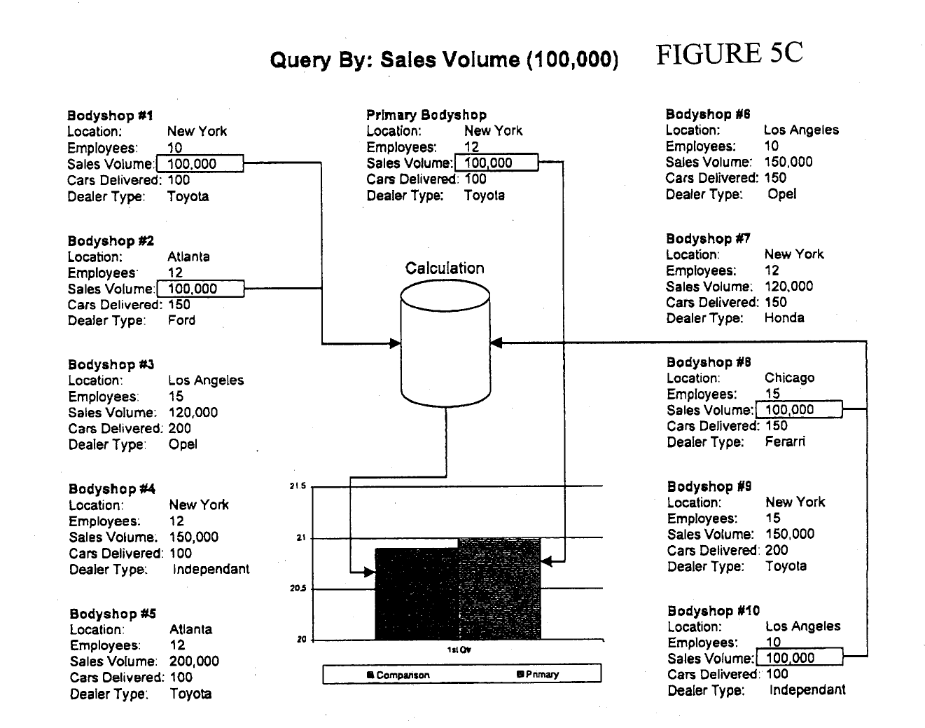

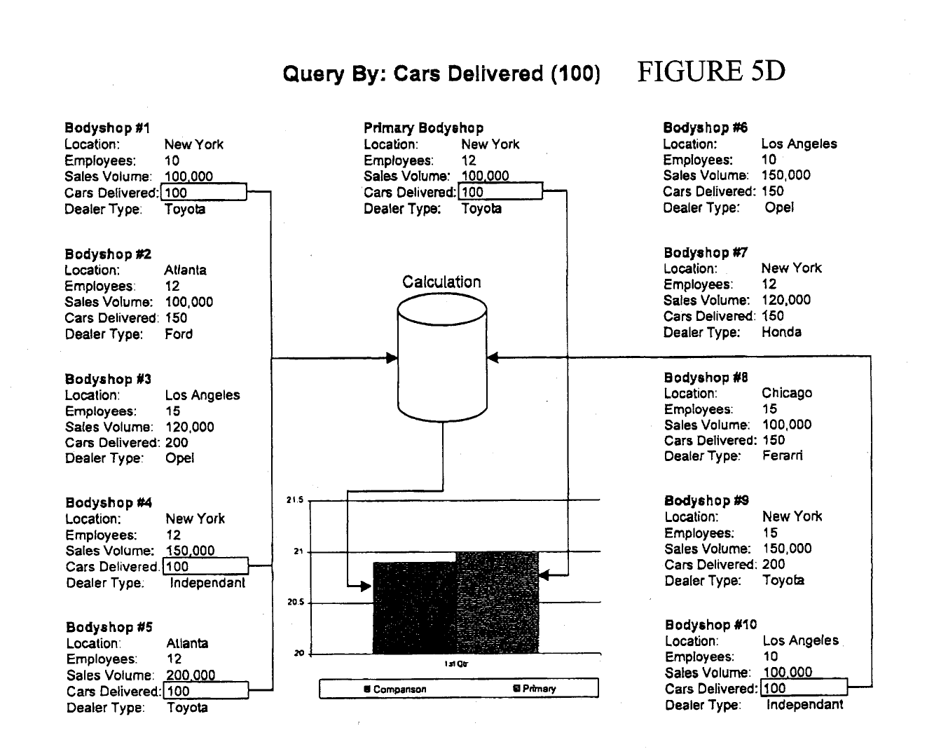

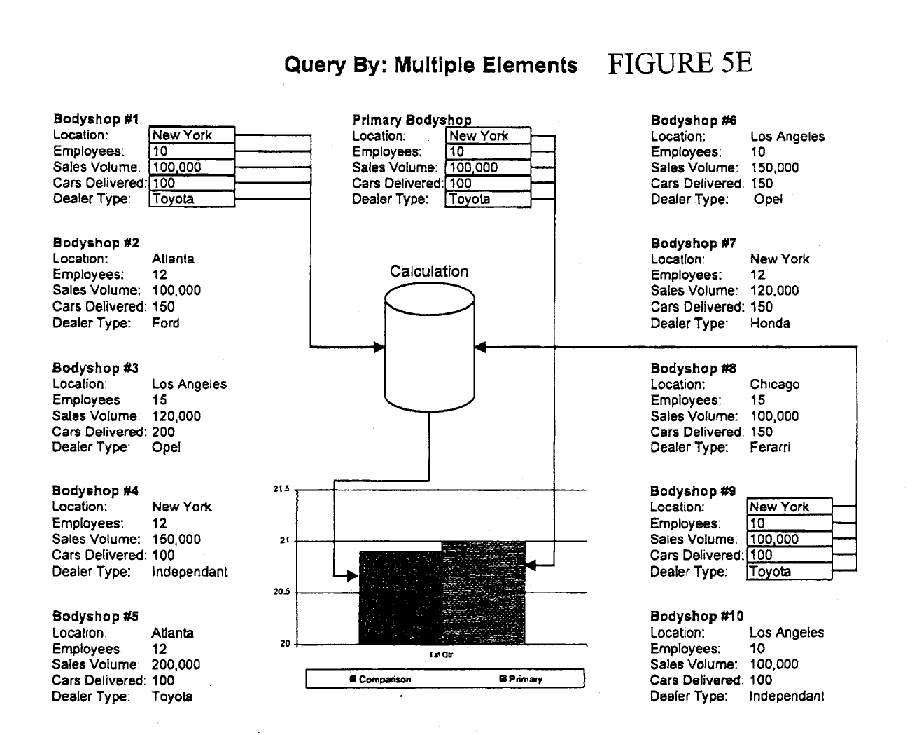

The invention is further described and illustrated by the following drawings. In the drawings, FIGS. 1-4 show flow diagrams of subsequent stages of the benchmarking process according to the invention. FIGS. 5A-E show the use of comparative key performance indicators allowing customized benchmarking by means of user defined queries.

In the drawings, communication between a user, a car repair body shop, and a server computer proceeds via a communication network, such as the Internet.

Via a user interface, the server computer requests the input of performance data as listed in four categories in FIG. 1. These performance data are used to calculate key performance indicators, or KPIs. The KPIs may be calculated on the basis of performance data from different categories, if so required. For instance, “Refinish Labour cost per vehicle” is calculated by division of the number of vehicles repaired (an operational datum) by the refinish labour cost (a financial datum).

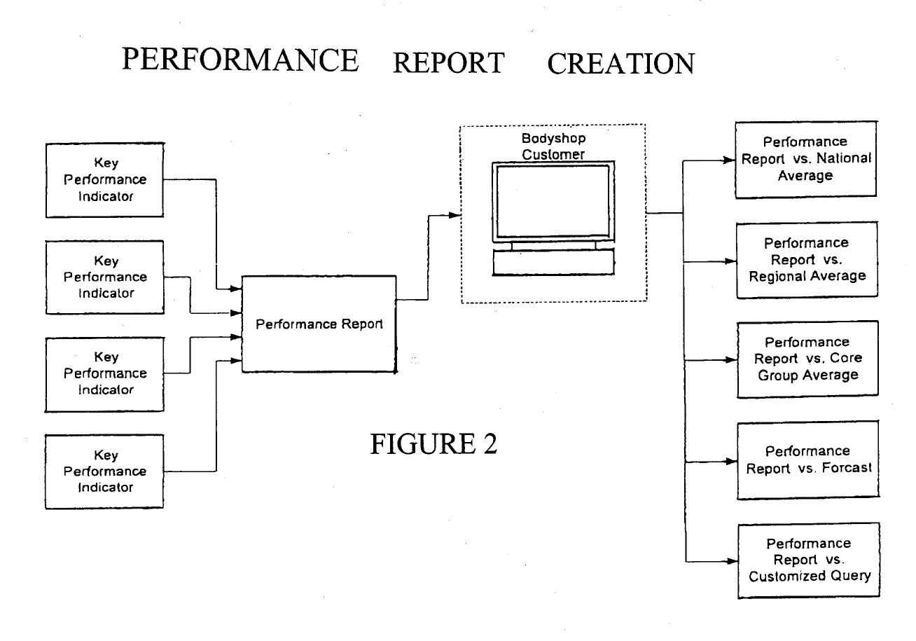

As shown in FIG. 2, the KPIs are combined in a report, which is presented to the client computer. The KPIs are compared to comparative key performance indicators selected by the user, e.g., average scores in a specific geographical area (e.g. global, national or regional average), scores of a pre-defined group, a former forecast of the user itself for the period in question, or comparative key performance indicators based on a customized query.

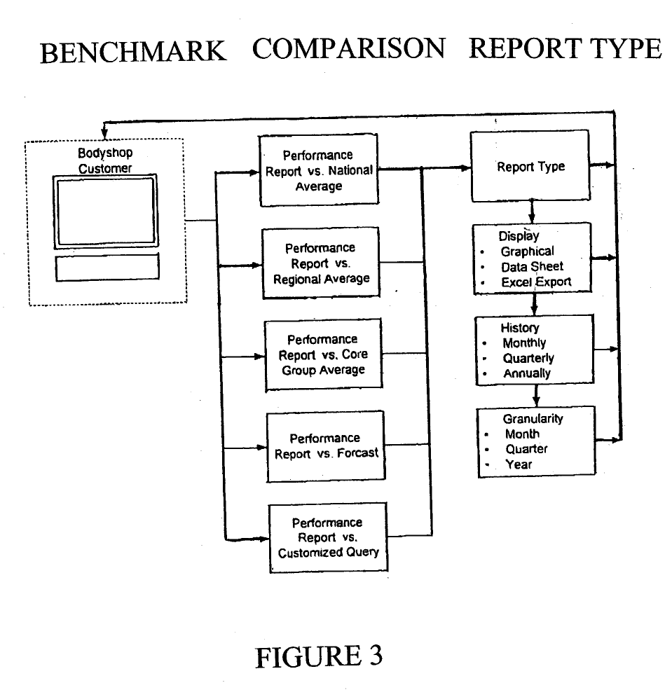

As shown in FIG. 3, the performance reports are subsequently issued in a suitable format, optionally to be selected by the user, which may prefer a datasheet or graphical display. It may be a monthly or annual report, or cover any suitable user-selected period of time, shown in a selected granularity (per month, per quarter, per year, etc.).

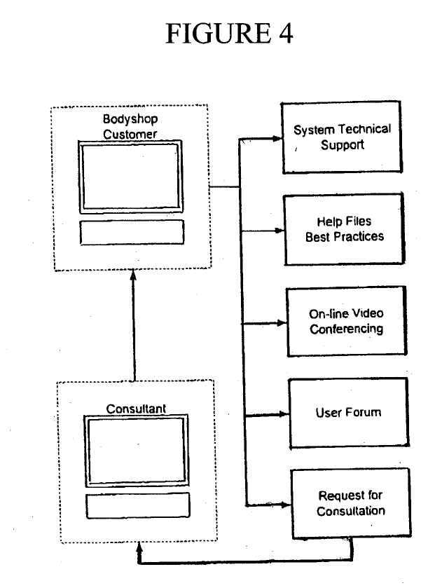

As shown in FIG. 4, the system can allow the user access to further facilities, e.g. contacting a consultant for additional advice, consulting help files or best practices or technical support. A video conferencing facility or a user forum facility (e.g., an Internet based news group) may be incorporated to discuss the report with a consultant and/or with other bodyshops.

In FIG. 5A a New York based bodyshop wishing to benchmark his performance can run a query to select bodyshops for a more specific comparison. In FIG. 5A, he selects bodyshops from the same area. He may want to compare with all other bodyshops in New York City, New York State or any other defined greater or smaller geographic area. or However, other criteria would be employee size (FIG. 5B), sales volume (FIG. 5C), the number of delivered cars within a defined range (FIG. 5D) or a combination of these. He may for instance want to compare with all bodyshops having a number of delivered cars between 80 and 120 or any other suitable range. The selection criteria are used by the computer to calculate and communicate the customized results.

1. A method for on-line performance analysis of a business entity using a server computer and one or more remote client computers linked to the server computer by a communication network, the method including:
providing a user interface on a client computer allowing input of performance data of the business entity;
defining one or more key performance indicators on the basis of the performance data;
providing a user interface on the client computer allowing selection of a type of comparative key performance indicator;
using the user's selection to generate one or more comparative key performance indicators on the basis of data of earlier sessions;
comparing one or more of the key performance indicators to the corresponding comparative key performance indicators;
deducing a performance analysis on the basis of the differences between the key performance indicators and the corresponding comparative key performance indicators, and
transferring the analysis to the client computer.

2. The method according to claim 1, wherein the server stores a database of performance parameters obtained from earlier sessions and in that a user interface is provided to the client computer, allowing input of one or more parameters for generating a comparative key performance indicator on the basis of a sub-database selected from the database on the basis of parameters inputted by the user.

3. The method according to claim 1, wherein one or more central administrators, preferably of different levels, have access to the database of performance parameters, e.g., for statistical analysis.

4. A method according to claim 3, wherein one or more of the central administrators have an authorization to define key performance indicators.

5. A method according to claims 1, wherein the user is a car repair body shop.

6. A method according claim 1, wherein the communication network is the Internet, an extranet or an intranet.

7. A computer program for on-line performance analysis of a business entity using a server computer and one or more remote client computers linked to the server computer by a communication network, wherein the computer program:
defines one or more key performance indicators on the basis of a user's input of performance parameters;
consults a database of data obtained from earlier sessions to generate one or more comparative key performance indicators on the basis of selection parameters inputted by the user;
comparing the indicators to the corresponding comparative indicator;
deducing a performance analysis on the basis of the differences between the key performance indicators and the corresponding comparative key performance indicators.

8. A data carrier storing a computer program according to claim 7.

9. A Server computer programmed by a computer program according to claim 7.

10. The server computer according to claim 9, wherein it comprises a memory storage medium storing a database of data obtained from earlier sessions.

11. A client computer programmed to provide a user interface allowing input of data for a computer program according to claim 7.
